(19) United States
(12) Patent Application Publication
(10) Pub. No.: US 2016/0059050 A1
(43) Pub. Date: Mar. 3, 2016

(54) LIGHT-WEIGHT, FLAME-RESISTANT COVERALLS WITH KNITTED, STRETCHABLE PORTION FOR UPPER TORSO

(71) Applicant: Lapco Manufacturing Inc., Morgan City, LA (US)

(72) Inventor: Jose Luis Gomez, New Iberia, LA (US)

(73) Assignee: Lapco Manufacturing, Inc., Morgan City, LA (US)

(21) Appl. No.: 14/474,795

(22) Filed: Sep. 2, 2014

(51) Int. Cl. A62B 17/00; A41D 13/008; A41D 13/02

(52) U.S. Cl. CPC A62B 17/003; A41D 13/02; A41D 13/008

(57) ABSTRACT

A light-weight, comfortable, flame resistant coveralls are herein disclosed. The coveralls have a bottom portion having two legs and a top portion having two arms. Both bottom and top portion are composed of a fabric and closures which meet NFPA 2112 (2012 Edition) fire protection standard and NFPA 70E Level 2 electrical protection standard. The bottom portion is made of a light-weight abrasion-resistant and snag resistant fabric of woven construction composed primarily of cotton fibers and yarns, but may include synthetic fibers and yarns to increase durability or other desired characteristics. The top portion is made of a light-weight fabric of a stretchable knitted construction composed primarily of cotton but may include synthetic fibers to increase stretchability, durability or other desired characteristics. The bottom and top portions are joined by a waist band stretchable at the back of the wearer. Adjacent the stretchable portion of the waist-band at the back of the wearer the fabric of the bottom and top portions are gathered to increase stretching of fabric at the back of the coveralls when the wearer bends forward.

### FIELD OF THE INVENTION

The invention herein disclosed relates one-piece human garments designed to cover the entirety of the body, except for head, neck, hands and feet and are sometimes referred to as coveralls, overall, boiler suits or flight suits (are herein collectively referred to as “coveralls”). More particularly the invention herein disclosed relates to coveralls which are designed to provide the wearer a certain level of protection from fire or electrical hazards which may exist in industrial working environments. More particularly the invention herein disclosed relates to coveralls which meet or exceed NFPA 2112 (2012 Edition) flame resistance standard and NFPA 70E Level 2 electrical protection standards. More particularly the invention herein disclosed relates to coveralls which meet or exceed NFPA 2112 (2012 Edition) and NFPA 70E Level 2 standards which nevertheless remain relatively comfortable to wear in hot, humid industrial working environments.

### GENERAL BACKGROUND

As used herein “coveralls” should be understood to mean a one-piece garment with full-length sleeves and legs. Other terms sometimes used to describe such garments are overalls, boilersuits, flight suits. Regardless of by what name such garments are called they have been in common use, usually in industrial settings, for decades if not longer.

As coveralls have been used in industrial and military applications, where workers wearing coveralls may be exposed to fire and electrical hazards, efforts have been made to make such garments inflammable, out of materials which do not melt and adhere to the skin and also to provide some protection from electrical hazards.

With increasing consciousness the safety of workers standards have been developed for clothing worn by workers in certain industrial environments. Two of these standards are NFPA 2112 (2012 Edition) flame resistant standard and NFPA 70E Level 2 electrical protection. These standards having been developed some governments now mandate clothing meeting or exceeding parts or all of these standards be worn in certain industrial environments; see, for example OSHA 29 CFR 1910.269.

While there is a need for protection of personnel working in certain industrial environments flame and electrical hazards, previous efforts to meet the above referenced NFPA standards have induced other problems, including but not necessarily limited to worker discomfort and heat stress.

Previous coveralls which meet the above NFPA standards have been made of heavy, woven materials which are hot, heavy and not stretchable.

There have been at least some attempts to address this problem, namely to provide coveralls which meet applicable OSHA and NFPA standards yet are more comfortable to wear. One such attempt is shown in United States Patent Application Number 20120210499 filed by Habash et al. It attempts to address the comfort problem by providing a horizontal vent disposed the shoulder blades of the wearer at the back of the in the top portion of the coverall. This vent is said to increase air circulation through the top portion, thereby reduce worker discomfort. However the entire Habash et al garment is made of non-stretchable thus must be made to fit loosely (is “baggy”) and with elongated crotch in order to allow a wearer to move about freely. Additionally because of safety concerns workers may not be permitted to be in hazardous location with the horizontal vent open. This prevents the vent from being used when the worker most needs it, rendering it useless when most needed or alternatively leading to safety rule violations. Neither is desirable. This indicates a need for a better solution to problem of providing coveralls which meet current OSHA and NFPA standards but are not so uncomfortable to wear in hot, humid work environments that they cause workers to suffer from heat stress or alternatively safety violations.

The invention herein discloses a coverall which meets current applicable OSHA and NFPA standards and is yet comfortable to wear in hot, humid work places.

### Objects of the Invention

The general object of the invention is to provide coveralls which meet or exceed NFPA 2112 (2012 Edition) and NFPA 70E Level 2 standards yet remain comfortable to wear in hot, humid industrial environments. A further object of the invention is to provide a coveralls with stretchable top portion, gathered at the back, to allow the top portion to elongate, thereby mitigate against tendency of the crotch of coveralls to move upward when the wearer bends forward. A further object of the invention is to provide coveralls which retains the above characteristics despite multiple launderings. Another object of the invention is to provide coveralls which are sufficiently resistant to abrasion and snagging to be used in an industrial environment.

### SUMMARY

A light-weight, comfortable, flame resistant coveralls are herein disclosed. The coveralls have a bottom portion having two legs and a top portion having two arms. Both bottom and top portion are composed of a fabric and closures which meet NFPA 2112 (2012 Edition) fire protection standard and NFPA 70E Level 2 electrical protection standard. The bottom portion is made of a light-weight abrasion-resistant and snag resistant fabric of woven construction composed primarily of cotton fibers and yarns, but may include synthetic fibers and yarns to increase durability or other desired characteristics. The top portion is made of a light-weight fabric of a stretchable knitted construction composed primarily of cotton but may include synthetic fibers to increase stretchability, durability or other desired characteristics. The bottom and top portions are joined by a waist band stretchable at the back of the wearer. Adjacent the stretchable portion of the waist-band at the back of the wearer the fabric of the bottom and top portions are gathered to increase stretching of fabric at the back of the coveralls when the wearer bends forward.

Said bottom portion may have cuffs, one or more pockets, pocket flaps, a close-able crotch opening and non-conductive closure means, including but not limited to buttons, zippers, snaps and hook/loop mechanisms.

Said top portion may have a collar, cuffs, one or more pockets, pocket flaps, a close-able front, side or back opening and non-conductive closure means, including but not limited to buttons, zippers, snaps and hook/loop mechanisms.

### BRIEF DESCRIPTION OF THE DRAWINGS

FIG. 1 is an illustration of the coveralls herein disclosed viewed from the front.

FIG. 2 is an illustration of the coveralls herein disclosed viewed from the back.

FIG. 3 is a illustration which represents an exploded view a back section of the waist-band of the coveralls herein disclosed.

### DESCRIPTION OF THE PREFERRED EMBODIMENT

While the present invention will be described with reference to preferred embodiments, it will be understood by those who are skilled in the art that various changes may be made and equivalents may be substituted for elements thereof without departing from the scope of the invention. In addition, many modifications may be made to adapt a particular situation or material to the teachings of the invention without departing from the essential scope thereof. It is therefore intended that the present invention not be limited to the particular embodiments disclosed as the best mode contemplated for carrying out this invention, but that the invention will include all embodiments and legal equivalents thereof.

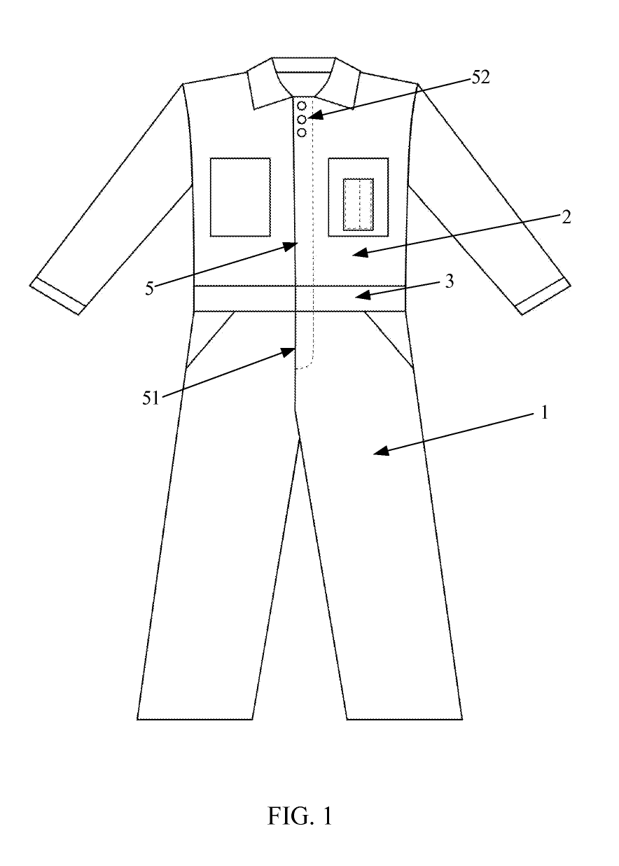

Referring to FIGS. 1, 2 and 3 it is seen that the coveralls of the invention are unitary construction, covering the torso, legs and arms of a wearer of the coveralls. The principal components of the unitary assembly are the bottom portion, 1, top portion 2 and waist-band 3.

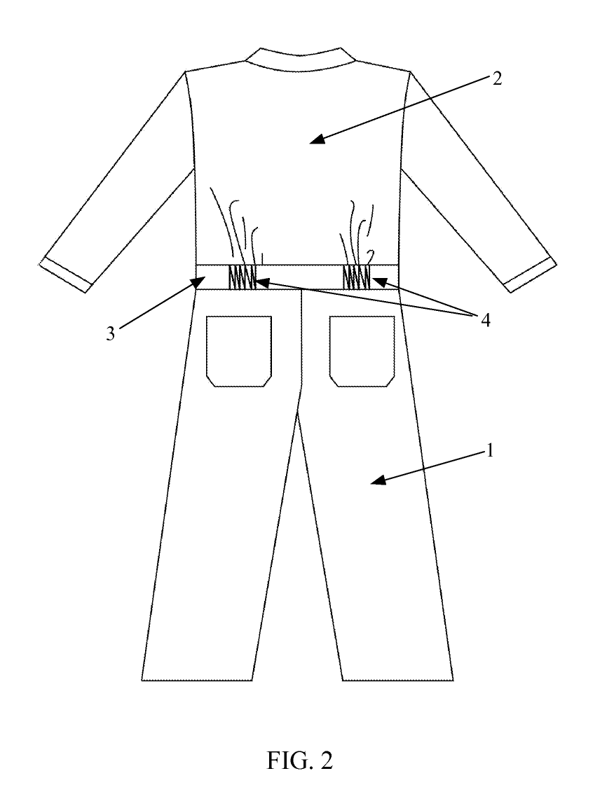

The first principal component of the coveralls, seen best in FIGS. 1 and 2, is bottom portion, 1. Bottom portion, 1, is configured to conform to the lower torso and legs of a human wearer, from waist to ankles. Bottom portion, 1, may be considered the “pants” portion of the coveralls. In preferred embodiment bottom portion, 1, will have two full-length leg portions (the bottom of which will typically extend below the top of a wearer's shoes), have a portion for seat and groin and extends upward into the waist-band, 3, of the wearer (which said waist-band, 3, it typically disposed about the top of the wearer's iliac crest). In preferred embodiment the bottom portion, 1, will have a frontal opening for toiletry purposes and to facilitate the wearer getting into and out of the coveralls. In the preferred embodiment of the coveralls the frontal opening is made close-able by zipper means, made of non-conductive flame resistant material, in the preferred embodiment a synthetic polymer, but other forms of closures, such as buttons, hooks and loops, strings may be used, so long as they are made of non-conductive materials and meet flame resistance requirements. The bottom of the leg portion of bottom portion, 1, will also be preferably hemmed to prevent raveling. Bottom portion, 1, may also be equipped with pockets, loops and ancillary features to facilitate the wearer carrying papers, writing tools, personal items, work tools and the like.

The fabric employed to construct the bottom portion, 1, of the coveralls is specially chosen to be light, comfortable and durable and to meet or exceed NFPA 2112 (2012 Edition) and NFPA 70E Level 2 despite multiple launderings. In preferred embodiment extra long strand cotton (sometimes referred to as “ELS”, “Pima” or “Supima”) yarns are primarily used to make the fabric of bottom portion, 1. Cotton is chosen a the preferred material because it is light, comfortable to touch, absorbs then readily evaporates moisture contained in perspiration and therefore, by evaporation, helps cool a wearer. Cotton is also chosen because it is subject to treatment with chemical formulations which polymerize with strands of cotton, make them self extinguishing, compliant with the above mentioned NFPA standards, and is not degraded by repeated laundering. Extra long strand cottons are preferred because they are more durable to repeated laundering. An extra long strand cotton fabric which is around 7 ounces per square yard is preferred.

While in the preferred embodiment of the invention the major component of the fabric of bottom portion, 1, is extra long strand cotton, the use of shorter strand cotton and the inclusion flame resistant synthetic fibers is intended to be comprehended within the scope of the invention herein disclosed. Use of shorter cotton fibers may reduce the cost of making bottom portion, 1, but be less durable. Use of some synthetic fibers is considered the best mode of practicing the invention herein disclosed so as to increase resistance of bottom portion, 1, which is particularly susceptible to exterior contact with abrasive surfaces particularly at the knees, back of the knees and buttocks of the wearer to abrasion, fraying and the like. In said best mode of the invention about twelve percent (12%) synthetic fibers are included in the fabric of the bottom portion, 1, for said purposes. In preferred embodiment the synthetic fibers are incorporated into the fabric by ring spinning synthetic fibers with cotton yarns. While nylon is considered the best synthetic fiber, other synthetic fibers which are flame resistant, durable, resistant to abrasion and fraying. Specifically the use of synthetic aramid, para-aramid and meta-aramid fibers is specifically comprehended to be within the scope of the invention.

In preferred embodiment of the invention bottom portion, 1, will be woven. In best mode a shirting twill of 3 to 1 ratio, about 110 warp threads per inch (48 fill threads per inch) is used with the technical face of the fabric at the exterior of the bottom portion, 1, the technical back of the fabric towards the wearer of the coveralls.

Some of the treads may be made of only cotton whereas some may be made of a cotton/synthetic mix of fibers, particularly with synthetic yarns applied by ring spinning, so as to create wales which contain exterior synthetic fibers, such as nylon, making the fabric more resistant to abrasion and fraying caused by contact with the exterior objects than twills made of pure cotton.

Such fabrics as are used to fabricate the best mode of the bottom portion, 1, of the coveralls of the invention herein disclosed are available from Westex, Inc., an Illinois, USA, corporation.

The bottom portion, 1, of the invention may include pockets, pocket flaps, hems, cuffs, loops and a close-able opening for toiletry purposes or to facilitate a wearer getting into and out of the coveralls. Various non-conductive and flame resistant closure means may be used including but not limited to button, snaps, zippers and hook and loop fastening means. Various synthetic polymers and natural substances may be used to form desired fastening mean. Thread used to stitch fabric pieces of bottom portion, 1, or attach buttons, snaps, zippers and hook and loop fastening means to bottom portion, 1, must not impair the ability of a finished coverall from meeting the NFPA standards mentioned above.

The second principal component of the coveralls, seen best in FIGS. 1 and 2, is top portion, 2. Top portion, 2, is configured to conform to the upper torso, from top of shoulders to waist of the wearer, and the arms of the wearer, from shoulder to wrist. The top portion, 2, may be considered the “shirt” portion of the coveralls. In preferred embodiment top portion, 2, will have two full-length arm portions (the end of which typically extends to wrist of the wearer, have a portion which extends over the shoulders and over the upper torso of the wearer (from neck of the wearer to horizontally disposed waist-band disposed about the waist of the wearer, disposed approximately at the top of the wearer's iliac crest). In preferred embodiment the bottom portion, 1, will have a close-able frontal opening to facilitate the wearer getting into and out of the coveralls.

The fabric employed to construct the top portion, 2, of the coveralls is specially chosen to be light, comfortable and durable and to meet or exceed NFPA 2112 (2012 Edition) and NFPA 70E Level 2 despite multiple launderings. In preferred embodiment extra long strand cotton (sometimes referred to as “ELS”, “Pima” or “Supima”) yarns are primarily used to make the fabric of top portion, 2. Cotton is chosen a the preferred material because it is light, comfortable to touch, absorbs then readily evaporates sweat and therefore cools the wearer. Cotton is also chosen because it is subject to treatment with chemical formulations which polymerize with strands of cotton, make them self extinguishing, compliant with the above mentioned NFPA standards, and maintains compliance with said standards after repeated, at least one-hundred, launderings. Extra long strand cottons are preferred because they are more durable to repeated laundering. An extra long strand cotton fabric which is around 7 ounces per square yard is preferred.

While in the preferred embodiment of the invention top portion, 2, is made of 100% extra long strand cotton fibers, use of shorter strand cotton fibers and inclusion of less that 50% synthetic fibers is intended to be comprehended within the scope of the invention herein disclosed. As indicated above with respect to bottom portion, 1, the use of nylon, aramid, para-aramid and meta-aramid fibers, which may be incorporated into the fabric by ring spinning or various other commonly used methods, may be included in the fabric used for top portion, 2, of the invention disclosed herein. Other synthetic fibers may be included so long as they do not cause top portion, 2, to fail to meet the mentioned NFPA standards do not fray with age, are sufficiently durable to withstand repeated laundering and repeated laundering does not deteriorate them to the point where the coveralls fail to meet NFPA standards.

In preferred embodiment of the invention top portion, 2, will be made of knitted yarns, employing a style or type of knit which results in a stretchable fabric. Because of its comfort and cooling characteristics, along with it ability to be made permanently flame resistant by treatment with chemical compositions which impart self-extinguishing characteristics the majority, if not all, of the fibers used to make top portion, 2, will be cotton. Extra long strand (“ELS”), pima or supima cotton is.

In the preferred embodiment of the invention top portion, 2, is made substantially entirely of flame resistant supima cotton fibers, made of 20/1 ring spun yard size, formed into a single jersey knit, having about 43 courses by 32 wales per inch, which has a weight of about 7 to 7.7 ounces/square yard. Such fabric is available from Antex Knitting Mills, a division of Matchmaster Dyeing and Finishing, Inc. a Los Angeles, USA, corporation.

In an alternative embodiment of the invention the top portion, 2, is made of yarn containing about of about 74% flame resistant supima cotton, about 23% flame resistant modal fibers and about 3% flame resistant spandex fibers formed into a single jersey knit, preferably as described above, or an interlock knit, made of 18/1 ring spun yarn, forming about 45 courses and 34 wales per inch and has a weight of 7 to 7.7 ounces per inch. Such interlock knit fabric is available from Antex Knitting Mills, a division of Matchmaster Dyeing and Finishing, Inc. a Los Angeles, USA, corporation.

In both of the above mentioned embodiments, and comprehended in all embodiments of the invention, top portion, 2, is specifically intended to be made of a light-weight, stretchable, knitted fabric comprised primarily of cotton fibers that meet the mentioned NFPA standards. By using such for top portion, 2, it can be made closer fitting without restraining ability of the wearer to move about and perform his or her duties. In particular top portion, 2, being made of stretchable fabric permits the back of top portion, 2, to elongate when a worker wearing the coveralls bends forward as the waist, hips or knees, rather than pull bottom portion, 1, upwards towards the worker's groin, thus permits the coveralls of the invention disclosed herein to be made with a less elongated, less baggy, thereby more comfortable crotch than previous coveralls. In addition the knitted construction of top portion, 2, is results in a top portion, 2, which is light-weight, allows for good air circulation and self-cooling when wetted with perspiration and therefore enhances the comfort wearing the coveralls even in a hot, humid environments.

The top portion, 2, of the invention may include a collar, pockets, pocket flaps, hems, cuffs, loops and a close-able frontal opening to facilitate the wearing getting into and out of the coveralls. In other embodiments the bottom portion, 1, may include close-able side or rear openings. Top portion, 2, may also include reinforcing patches at points, like the elbows, particularly susceptible to wear. These patches may be of knitted or woven fabrics or natural substances like leather. In choosing the material for said reinforcing patches care must be taken to make sure they do not impair ability of top portion, 2, or the coveralls from meeting NFPA standards. Various non-conductive and flame resistant closure means may be used including but not limited to button, snaps, zippers and hook and loop fastening means. Various synthetic polymers and natural substances may be used to form desired fastening mean. Thread used to stitch fabric pieces used to form top portion, 2, must be non-conductive of electricity or impair the ability of the coveralls to meet NFPA standards. In preferred embodiment a thread comprised of fire resistant cotton fibers but having some fire resistant synthetic fibers, in preference fire resistant nylon and/or fire resistant aramid fibers is used.

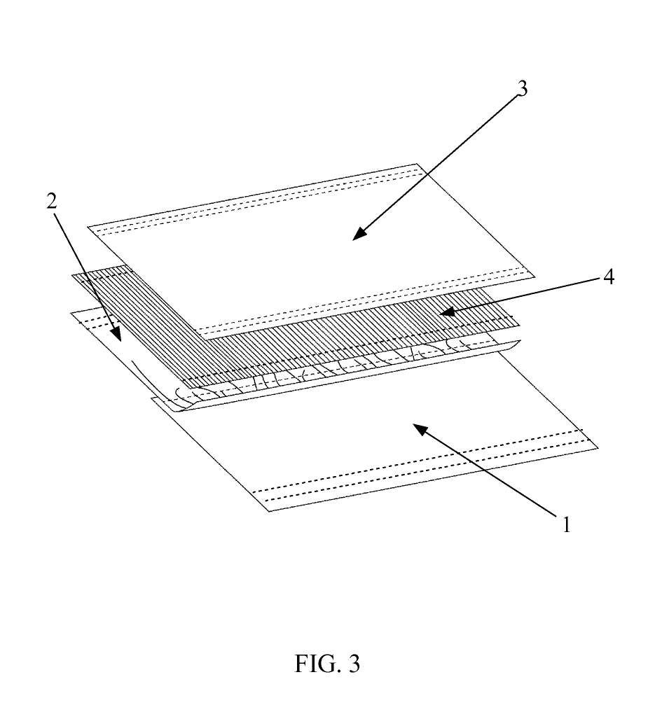

The third major portion of the coveralls of the invention herein disclosed is waist-band, 3. FIG. 3 is an exploded view of the preferred embodiment of a portion of a portion of the waist-band of a portion of the waist-band of the coveralls of the invention adjacent to a portion of the back-side of a wearer of said coveralls. In the preferred embodiment of the invention bottom portion, 1 and top portion, 2, are attached directly to each other, along and are also indirectly joined together by both also being attached waist-band, 3. In order to get enhance the effect of the top portion, 2, being made of stretchable fabric (capable of elongating in the direction of a wearer's spine when the wearer bends his or her body at the waist, hip or knees) waist-band, 3, is also made at least partially stretchable along the back-side of the wearer of the coveralls of the invention. In preferred embodiment this is accomplished by stretching a strip of elastic, 4, and as shown in FIG. 3, attaching same to the top of bottom portion, 1, the bottom of top portion, 2, and waist-band, 3, while said elastic strip, 4, is stretched. When the strip of elastic, 4, is allowed to rebound it “gathers” top of bottom portion, 1, the bottom of top portion, 2, and waist-band, 3, to the un-stretched elastic. In the preferred embodiment of the invention this “gathering” is disposed at the back-side of a wearer of the coveralls, thereby enhancing the ability of top portion, 2, which is made of a stretchable knit fabric to elongate in the direction of the wearer's spine when the wearer of the coveralls bends forward at the waist, hips or knees, thereby reducing the tendency of the crotch of the coveralls to ride upward and bind the wearer's crotch when such movements are made. This permits the coveralls of the invention to be made with shorter length crotches that previous coveralls, made entirely of non-stretchable fabric. In preferred embodiment of the invention the above described gathering takes place along two portions of the waist-band which are contiguous with the back-side of a wearer, as shown in FIG. 2. It will be appreciated by those skilled in the art that while the construction described above has certain advantages, it is not actually necessary that elastic strip, 4, be attached to bottom portion, 1, top portion, 2, and waist-band, 3, in order to create a stretchable gathering of the fabric of top portion, 2, at the back-side of the wearer, it is only necessary that elastic strip, 4, be attached to at least one of the group of fabric consisting of bottom portion, 1, top portion, 2, and waist-band, 3, or by one or more strips of elastic, 4, attached above or below waist-band, 3. All of such variances are intended to be comprehended within the scope of the invention herein disclosed and claimed.

This gathering of the fabric of upper portion, 2, allows it to stretch more when the wearer bends at the waist, thereby reducing the propensity of bottom portion, 1, to ride up into the wearer's crotch when the wearer bends at the waist, thereby allowing the crotch of the invention to be shortened as compared to coveralls made entirely of non-stretchable fabric. The elongated crotches of previous coveralls, which were made entirely of non-stretchable fabric, is an attribute of those coveralls which is commonly complained off by wearers. But the crotch of previous coveralls was necessarily elongated to permit a wearer to bend at the waist, hips and knees without binding the wearer's groin. Accordingly the invention herein disclosed mitigates the against the need to elongate the length of the crotch of coveralls.

The coveralls of the invention herein disclosed also includes a close-able opening, 5, which allows the wearer to get into and out of the coveralls. In the preferred embodiment of the invention said opening, 5, will be at the front of the coveralls and extend from bottom of the fly, 51, of bottom portion, 1, of the invention, through waist-band, 3, and at least part of the way upward (towards the neck of the wearer) through top portion, 2, of the coveralls. In particularly preferred embodiment of the invention said opening will be made open-able and close-able by zipper means which in this embodiment of the invention if preferably has a flap of adjacent fabric covering it, not only to give the coveralls a more finished appearance, but to mitigate against the teeth of the zipper getting gritty substances on them and to provide the zipper with a fire resistance covering. Other means of opening/closing clothing items, well know, are intended to be embraced by the scope of the coveralls herein disclosed.

If a zipper closure means is used, button, 52, or other fastening devices well known in the clothing field, including but not limited to ties, straps and buckles, snaps, hook and loop fasteners may be used above the zipper, to reduce strain at the top of the zipper, or for cosmetic purposes.

Whatever closure means is used they must not impair the ability of the coveralls to meet the above mentioned NFPA standards. In order to meet electrical protection requirements said closure means, and all other parts of the coveralls of the invention, may not be conductive of electricity. In preferred embodiment heat resistant synthetic polymers (sometimes referred to as “plastic” materials) is preferred, but natural substances, such as leather, bone, wood are not excluded from the scope of the invention.

Because many varying and different embodiments may be made within the scope of the inventive concept herein taught, and because many modifications may be made in the embodiments herein detailed in accordance with the descriptive requirement of the law, it is to be understood that the details disclosed herein are to be understood as illustrative and not in any limiting sense.

What is claimed is:

1. A light-weight fire resistant coveralls to be worn as clothing by a human having a waist and a back-side thereof:
comprising a bottom portion and a top portion, a waist-band and a strip of elastic;
wherein said bottom portion is comprised of a fabric consisting primarily of woven yarns consisting primarily of flame resistant cotton fibers and is connected to said top portion and to said waste-band;
wherein said top portion is comprised of a fabric consisting primarily of knitted yarns consisting primarily of flame resistant cotton fibers and is connected to said bottom portion and to said waste-band;
wherein said waist-band is comprised of a fabric consisting primarily of yarns consisting primarily of flame resistant cotton fibers and is connected to said bottom portion and to said top portion; and,
wherein, at the back-side of the wearer, said elastic strip is attached to at least one of the group of fabric consisting of said bottom portion, said top portion and said waist-band while said elastic is being stretched, thereby gathering said group of fabric across at least a portion of the back-side of said wearer when not being stretched.

2. The coveralls of claim 1 wherein the weave of the fabric of said bottom portion is comprised of a twill weave.

3. The coveralls of claim 2 wherein said fabric of said bottom portion is further comprised of flame resistant synthetic fibers.

4. The coveralls of claim 3 wherein said flame resistant synthetic fibers are comprised of flame resistant nylon.

5. The coveralls of claim 1 wherein the knit of the fabric of said top portion is comprised of stretchable knitting stitches.

6. The coveralls of claim 5 wherein said stretchable knitting stitches are comprised of jersey knitting stitches.

7. The coveralls of claim 6 wherein said stretchable knitting stitches are comprised of single jersey knitting stitches.

8. The coveralls of claim 5 wherein said stretchable knitting stitches are comprised of interlock knitting stitches

9. The coveralls of claim 5 wherein said fabric of said top portion is further comprised of flame resistant synthetic fibers.

10. The coveralls of claim 9 wherein said flame resistant synthetic fibers are comprised of flame resistant modal fibers.

11. The coveralls of claim 10 wherein said flame resistant synthetic fibers are comprised of flame resistant spandex fibers.

12. The coveralls of claim 1, wherein said fabric of said bottom portion is comprised of woven yarns configured to form a twill wherein said yarns further comprise flame resistant nylon fibers and said fabric of said top portion is comprised of knitted yarns configured to form a single jersey knit.

13. The coveralls of claim 1, wherein said fabric of said bottom portion is comprised of woven yarns configured to form a twill wherein said yarns further comprise flame resistant nylon fibers and said fabric of said top portion is comprised of knitted yarns configured to form an interlock knit.

14. The coveralls of claim 12, wherein said fabric of said bottom portion is further comprised of flame resistant synthetic fibers.

15. The coveralls of claim 14, wherein said flame resistant synthetic fibers are comprised of flame resistant modal fibers.

16. The coveralls of claim 14, wherein said flame resistant synthetic fibers are comprised of flame resistant spandex fibers.

17. The coveralls of claim 13, wherein said fabric of said bottom portion is further comprised of flame resistant synthetic fibers.

18. The coveralls of claim 17, wherein said flame resistant synthetic fibers are comprised of flame resistant modal fibers.

19. The coveralls of claim 17, wherein said flame resistant synthetic fibers are comprised of flame resistant spandex fibers.
